(19) United States
(12) Patent Application Publication
(10) Pub. No.: US 2011/0187018 A1
(43) Pub. Date: Aug. 4, 2011

(54) CROSSLINKED FIBERS OR OTHER ARTICLES MADE FROM POLYOLEFIN ELASTOMERS

(75) Inventors: Hong Peng, Columbus, OH (US); Jerry C. Wang, Taichung (TW); Hongyu Chen, Shanghai (CN); John D. Weaver, Pearland, TX (US); Stephen E. Hill, Angleton, TX (US); Yushan Hu, Pearland, TX (US); Richard C. Abel, Lake Jackson, TX (US)

(73) Assignee: Dow Global Technologies Inc., Midland, MI (US)

(21) Appl. No.: 12/946,579

(22) Filed: Nov. 15, 2010

Related U.S. Application Data
(60) Provisional application No. 61/267,607, filed on Dec. 8, 2009.

(51) Int. Cl. D01D 5/00; C08L 51/06; C08L 53/00

(52) U.S. Cl. 264/211.12; 525/70; 525/71

(57) ABSTRACT

The invention relates to an improved process for controlling the amount of crosslinking in polyolefin based articles such as fibers or films. The invention relates to mixing silane grafted material together with ungrafted material prior to crosslinking. The article can then be formed and cured, optionally with a curing catalyst which can preferably be applied to the surface of a shaped article. The amount of crosslinking will be controlled in part by the level of silane grafting on the grafted silane material as well as the amount of the grafted material in the blend.

This application is a non-provisional application claiming priority from the U.S. Provisional Patent Application No. 61/267,607, filed on Dec. 8, 2009, entitled “CROSSLINKED FIBERS OR OTHER ARTICLES MADE FROM POLYOLEFIN ELASTOMERS,” the teachings of which are incorporated by reference herein, as if reproduced in full hereinbelow.

The present invention relates to an improved process for crosslinking polyolefin polymers, compositions made from the process, and articles such as fibers made from the compositions. More particularly the invention relates to an improved process for controlling the amount of crosslinking in polyolefin based articles such as fibers or films. The invention relates to mixing silane grafted material together with ungrafted material prior to crosslinking. The article can then be formed and cured, optionally with a curing catalyst which can preferably be applied to the surface of a shaped article. The amount of crosslinking will be controlled in part by the level of silane grafting on the grafted silane material as well as the amount of the grafted material in the blend.

For many applications it is desired to introduce chemical linkages between the polymeric molecular chains which constitute the polymer, during or preferably following the shaping or molding process. These chemical linkages are generally known as “crosslinks” Crosslinks can be introduced between different molecular chains of polyolefins by a number of mechanisms, including high energy electron beaming. Another method of introducing crosslinks is to graft a chemically reactive compound to the individual polymer backbones or chains that constitute the bulk polymer in such a manner that the grafted compound on one backbone may subsequently react with a similar grafted compound on another backbone to form a crosslink. The silane crosslinking process is an example of this method.

The process of silane-grafting and subsequent crosslinking involves first grafting a hydrolyzable silane onto the backbone of the polymer and then subsequently hydrolyzing the compounds and allowing the formation of crosslinks. The grafting is typically achieved in a reactive extrusion step using a reactive grafting package, which may include a vinyl silane and a free radical initiator (for example a peroxide or an azo compound). Current reactive grafting packages also typically include a catalyst for the hydrolysis and crosslinking reactions. Although not intending to be bound by theory, it is believed that the free radical initiator serves to extract hydrogen from the polymeric molecular backbone, facilitating the grafting of vinyl silane. The level of crosslinking will depend on the level of grafting.

After grafting, the polymer is typically molded or shaped into a finished article and then the crosslinking or “curing” reaction is facilitated. These articles include molded articles, foams, films and fibers. Since the molding or shaping process is usually carried out at elevated temperatures, some crosslinking typically occurs during the molding or shaping process, particularly when the curing catalyst is added prior to the article formation step. In many cases this crosslinking during the shaping process is undesirable. For example, when the polymer is shaped into a fiber using typical spinning lines, crosslinking will lead to increased rates of fiber breaks, especially at higher line speeds.

In order to prepare fibers economically, the silane grafted polyolefin resins must be spinnable at high line speeds with minimal fiber breaks. This need must be balanced against the desire for sufficient levels of crosslinking in the final product. Crosslinking of the fibers gives the fiber heat resistance, which, for example, allows the fiber to be used in fabrics that are subjected to elevated temperatures in processing or cleaning. Heat resistance allows the fiber to maintain its shape and integrity even at temperatures above the crystalline melting point of the fiber. Crosslinking also provides high temperature elastic recovery. Higher levels of silane grafting are needed for higher levels of crosslinking in the final product, but also lead to higher levels of crosslinks forming during processing. Depending on the intended use of the article, the balance between processability and degree of cross-linking in the final product may shift.

Conventional methods of balancing the interests of spinnability versus sufficient crosslinking in the final product involved the use of slower curing catalysts, such that crosslinking was minimized during the shaping step. It has also been suggested that in order to improve spinnability the resin should have a lower starting molecular weight. Alternatively, it has been suggested that inhibitors such as styrene monomer can be used to minimize the undesired chain coupling reactions. However, these inhibitors result in environment, health and safety issues, when the fiber is intended for public use such as in apparel applications.

DE 19609419 A1 discloses an elastic fiber made from polyethylene using silane crosslinking chemistry. This reference teaches adding 15-30 percent by weight of a paraffin plasticizer for reducing viscosity during melt processing and lowering the hardness of the fiber products. Such paraffin plasticizers have also been found to reduce the mechanical properties of the fibers.

DE 19823142 A1 claims the silane grafting of blends of at least two ethylene octene copolymers in the presence of styrene. The blends were used to overcome the disadvantages of the paraffin plasticizer and the styrene was used to minimize undesired coupling reactions. However the crosslinked fibers exhibit low tenacity due to the low molecular weight component of the blend, and suffer the disadvantages associated with the use of styrene as discussed previously.

U.S. Pat. No. 5,741,858, U.S. Pat. No. 5,824,718 and U.S. Pat. No. 6,048,935 disclose silane grafted substantially linear ethylene polymers which are useful in various applications including elastic fiber and exhibit superior elastic behavior at elevated temperatures. These references teach using weight ratios of silane crosslinking compound to radical initiators in the range of 10:1 to 30:1.

U.S. Pat. No. 5,883,144, U.S. Pat. No. 6,103,775 and U.S. Pat. No. 6,316,512 also teach silane grafted polyolefin articles, but do not teach preferred ratios of silane to peroxide functionality for optimum fiber spinnability.

EP 1 592 720 B1 teaches that the ratio of silane to free radicals should be kept high to provide for optimal levels of silane grafting and that any hydrolysis catalyst should be added only after the article has been formed.

New methods for controlling the level of silane grafting and crosslinking are desired such that the grafting levels in the polyolefin material can be optimized for a particular use. It is particularly desired to have a process such that the material can be used to make fibers and/or films under the high speeds of typical production equipment while maintaining the sufficient crosslinking levels in the final product so that the preferred mechanical and thermal properties are maintained. It is further desired that the process allows the use of resins of varying molecular weights, minimize the use of additives such as styrene, and further minimize the use of certain catalysts. It is also desired that the method allow easily adjustable tailoring of the specific level of silane grafting such that the resin may be easily tailored for a specific end-use.

It has been discovered that these and other advantages can be achieved by blending or otherwise mixing silane grafted polyolefin together with an amount of ungrafted polymer. In accordance with the present invention silane grafting can be carried out on any desired polyolefin polymer at whatever levels are convenient. This silane grafted material can then be blended with non-grafted material at levels to provide the desired grafting levels in the final product. Surprisingly, it has been found that such blending can produce a uniform morphology both before and after crosslinking, making this technique well suited for fiber spinning and other manufacturing processes.

### BRIEF DESCRIPTION OF THE DRAWINGS

FIG. 1 is a plot of the amount of silane grafted resin versus the resulting gel content for examples 1-5.

FIG. 2 is a plot showing the relations of gel content versus grafting level for the single component and blend systems for resin examples B, F1, F2, F3 and E.

FIG. 3 is a bar graph showing the cup depth of molded bras made from comparative Example 13, Example 14 and a Spandex fabric at varying molding temperatures.

### DETAILED DESCRIPTION OF THE INVENTION

In a first embodiment the present invention comprises a method for producing a crosslinked polyolefin based fiber. The method comprises obtaining an amount of a first polyolefin based polymer which has silane moieties grafted thereon. An amount of a second polyolefin based polymer is then obtained. The second polyolefin based polymer is substantially free of units derived from silane. These materials are then blended or otherwise mixed together. The mixture is then used to spin a fiber. After the fiber has been formed it is exposed to conditions capable of facilitating a crosslinking reaction between silane moieties.

Polyolefin based polymers capable of serving as the first polymer can be any polymer with a unit derived from an olefin as a repeating unit. Preferred polyolefin based polymers for the method of the present invention include olefin block copolymers (“OBC”), propylene based plastomers or elastomers (“PBPE”) and linear or substantially linear low density polyethylenes (“LLDPE”).

The preferred LLDPE ethylene copolymers suitable for use as the first polymer in the method of the present invention can be an interpolymer of ethylene with at least one C₃-C₂₀ alpha-olefin, as stated in U.S. 2003/0032731. Preferably the ethylene copolymer is a copolymer of ethylene with 1-butene, 1-hexene, or 1-octene, with 1-octene being the most preferred. The ethylene copolymers suitable for use as the third polymer may be linear (that is, with no long chain branching) or substantially linear. The ethylene copolymer may advantageously be made using a gas phase process or a solution process as is known in the art, although solution is generally preferred in order to produce polymer with lower densities. Similarly, the catalyst used to make the LLDPE is not limited and includes Ziegler Natta type catalysts as well as metallocenes. Exemplary ethylene copolymers for use in the present invention include EXACT™ polymers from Exxon-Mobil Chemical Company, AFFINITY™ polymers and ENGAGE™ polymers from The Dow Chemical Company, and TAFMER™ polymers from Mitsui Chemicals. Exemplary ethylene copolymers for use in the present invention have density ranges from 0.86 to 0.91 (g/cm³) as measured by ASTM D-792, a melt index ASTM D-1238, (2.16 kg, 190° C.) from 0.5 to 10 g/10 minutes, and a have a narrow MWD, preferably less than 3.0.

The PBPE materials suitable for use as the first polyolefin based polymer in the method of the present invention comprise at least one copolymer with at least about 50 weight percent of units derived from propylene and at least about 1 weight percent of units derived from a comonomer other than propylene. Suitable propylene based elastomers and/or plastomers are taught in WO03/040442, and WO2007/024447, each of which is hereby incorporated by reference in its entirety.

Of particular interest for use in the present invention are reactor grade PBPEs having MWD less than 3.5. It is intended that the term “reactor grade” is as defined in U.S. Pat. No. 6,010,588 and in general refers to a polyolefin resin whose molecular weight distribution (MWD) or polydispersity has not been substantially altered after polymerization. The preferred PBPE will have a heat of fusion (as determined using the DSC method described in WO2007/0244447) less than about 90 Joules/gm, preferably less than about 70 Joules/gm, more preferably less than about 50 Joules/gm. When ethylene is used as a comonomer, the PBPE has from about 0.04 to about 15 percent of ethylene, or from about 5 to about 14 percent of ethylene, or about 7 to 12 percent ethylene, by weight of the propylene based elastomer or plastomer.

Although the remaining units of the propylene copolymer are derived from at least one comonomer such as ethylene, a C₄₋₂₀α-olefin, a C₄₋₂₀ diene, a styrenic compound and the like, preferably the comonomer is at least one of ethylene and a C₄₋₁₂α-olefin such as 1-hexene or 1-octene. Preferably, the remaining units of the copolymer are derived only from ethylene.

The amount of comonomer other than ethylene in the propylene based elastomer or plastomer is a function of, at least in part, the comonomer and the desired heat of fusion of the copolymer. If the comonomer is ethylene, then typically the comonomer-derived units comprise not in excess of about 15 wt % of the copolymer. The minimum amount of ethylene-derived units is typically at least about 1, preferably at least about 3, more preferably at leas about 5 and still more preferably at least about 9, wt % based upon the weight of the copolymer. If the polymer comprises at least one other comonomer other than ethylene, then the preferred composition would have a heat of fusion approximately in the range of a propylene-ethylene copolymer with about 3 to 20 percent by weight ethylene. The propylene based plastomer or elastomer of this invention can be made by any process, and includes copolymers made by Ziegler-Natta, CGC (Constrained Geometry Catalyst), metallocene, and nonmetallocene, metal-centered, heteroaryl ligand catalysis. These copolymers include random, block and graft copolymers although preferably the copolymers are of a random configuration. Exemplary propylene copolymers include Exxon-Mobil VISTAMAXX™ polymer, and VERSIFY™ propylene/ethylene elastomers and plastomers by The Dow Chemical Company.

The density of the propylene based elastomers or plastomers of this invention is typically at least about 0.850, can be at least about 0.860 and can also be at least about 0.865 grams per cubic centimeter (g/cm³) as measured by ASTM D-792. Preferably the density is less than about 0.893 g/cc.

The weight average molecular weight (Mw) of the propylene based elastomers or plastomers of this invention can vary widely, but typically it is between about 10,000 and 1,000,000, alternatively between about 50,000 and 500,000 or between 100,000 and 250,000 (with the understanding that the only limit on the minimum or the maximum M_{w} is that set by practical considerations).

The polydispersity of the propylene based elastomers or plastomers of this invention is typically between about 2 and about 5. “Narrow polydispersity”, “narrow molecular weight distribution”, “narrow MWD” and similar terms mean (whether applied to propylene based elastomers or plastomers or other polymers) a ratio (M_{w}/Mₙ) of weight average molecular weight (M_{w}) to number average molecular weight (Mₙ) of less than about 3.5, can be less than about 3.0, can also be less than about 2.8, can also be less than about 2.5.

The PBPEs for use in the present invention ideally have an MFR of from 0.2 to 2000 g/10 min, preferably from about 0.5 to 1000, more preferably from about 2 to 500, still more preferably from about 2 to 40. The particular MFR selected will depend in part on the intended fabrication methods such as fiber spinning, blown film, extrusion coating, sheet extrusion, injection molding or cast film processes. MFR for copolymers of propylene and ethylene and/or one or more C₄-C₂₀α-olefins is measured according to ASTM D-1238, condition L (2.16 kg, 230° C.).

MFRs greater than about 250 were estimated according to the following correlation:

MFR=9×10¹⁸Mw^{-3.3584}
Mw (grams per mole) was measured using gel permeation chromatography.

The olefin block copolymers suitable for use as the first polymer in the method of the present invention are a relatively new class of material which are more fully described in WO 2005/090427, US2006/0199931, US2006/0199930, US2006/0199914, US2006/0199912, US2006/0199911, US2006/0199910, US2006/0199908, US2006/0199907, US2006/0199906, US2006/0199905, US2006/0199897, US2006/0199896, US2006/0199887, US2006/0199884, US2006/0199872, US2006/0199744, US2006/0199030, US2006/0199006 and US2006/0199983; each publication being fully incorporated herein by reference. Olefin block copolymers are also known as “OBCs” or olefin multi-block interpolymers,

The OBCs may be made with two catalysts incorporating differing quantities of comonomer and a chain shuttling agent. Preferred olefin multi-block interpolymers are ethylene/α-olefin multi-block interpolymers. The ethylene/α-olefin multi-block interpolymers typically comprise ethylene and one or more copolymerizable α-olefin comonomers in polymerized form, characterized by multiple blocks or segments of two or more polymerized monomer units differing in chemical or physical properties. That is, the ethylene/α-olefin interpolymers are block interpolymers, preferably multi-block interpolymers or copolymers.

The ethylene multi-block polymers typically comprise various amounts of “hard” and “soft” segments. “Hard” segments refer to blocks of polymerized units in which ethylene is present in an amount greater than about 95 weight percent, and preferably greater than about 98 weight percent based on the weight of the polymer. In other words, the comonomer content (content of monomers other than ethylene) in the hard segments is less than about 5 weight percent, and preferably less than about 2 weight percent based on the weight of the polymer. In some embodiments, the hard segments comprise all or substantially all ethylene. “Soft” segments, on the other hand, refer to blocks of polymerized units in which the comonomer content (content of monomers other than ethylene) is greater than about 5 weight percent, preferably greater than about 8 weight percent, greater than about 10 weight percent, or greater than about 15 weight percent based on the weight of the polymer. In some embodiments, the comonomer content in the soft segments can be greater than about 20 weight percent, greater than about 25 weight percent, greater than about 30 weight percent, greater than about 35 weight percent, greater than about 40 weight percent, greater than about 45 weight percent, greater than about 50 weight percent, or greater than about 60 weight percent.

The soft segments can often be present in a block interpolymer from about 1 weight percent to about 99 weight percent of the total weight of the block interpolymer, preferably from about 5 weight percent to about 95 weight percent, from about 10 weight percent to about 90 weight percent, from about 15 weight percent to about 85 weight percent, from about 20 weight percent to about 80 weight percent, from about 25 weight percent to about 75 weight percent, from about 30 weight percent to about 70 weight percent, from about 35 weight percent to about 65 weight percent, from about 40 weight percent to about 60 weight percent, or from about 45 weight percent to about 55 weight percent of the total weight of the block interpolymer. Conversely, the hard segments can be present in similar ranges. The soft segment weight percentage and the hard segment weight percentage can be calculated based on data obtained from DSC or NMR. Such methods and calculations are disclosed in WO/2008/080111, entitled “Ethylene/α-Olefin Block Interpolymers”, with a priority date of Mar. 15, 2006, in the name of Colin L. P. Shan, Lonnie Hazlitt, et. al. and assigned to Dow Global Technologies Inc., the disclosure of which is incorporated by reference herein in its entirety.

The term “multi-block copolymer” or “segmented copolymer” refers to a polymer comprising two or more chemically distinct regions or segments (referred to as “blocks”) preferably joined in a linear manner, that is, a polymer comprising chemically differentiated units which are joined end-to-end with respect to polymerized ethylenic functionality, rather than in pendent or grafted fashion. In a preferred embodiment, the blocks differ in the amount or type of comonomer incorporated therein, the density, the amount of crystallinity, the crystallite size attributable to a polymer of such composition, the type or degree of tacticity (isotactic or syndiotactic), regio-regularity or regio-irregularity, the amount of branching, including long chain branching or hyper-branching, the homogeneity, or any other chemical or physical property. The multi-block copolymers are characterized by unique distributions of polydispersity index (PDI or Mw/Mn), block length distribution, and/or block number distribution due to the unique process making of the copolymers. More specifically, when produced in a continuous process, the polymers desirably possess PDI from 1.7 to 2.9, preferably from 1.8 to 2.5, more preferably from 1.8 to 2.2, and most preferably from 1.8 to 2.1. When produced in a batch or semi-batch process, the polymers possess PDI from 1.0 to 2.9, preferably from 1.3 to 2.5, more preferably from 1.4 to 2.0, and most preferably from 1.4 to 1.8.

In one embodiment, an ethylene/α-olefin multi-block interpolymer has an ethylene content of from 60 to 90 percent, a diene content of from 0 to 10 percent, and an α-olefin content of from 10 to 40 percent, based on the total weight of the polymer. In one embodiment, such polymers are high molecular weight polymers, having a weight average molecular weight (Mw) from 10,000 to about 2,500,000, preferably from 20,000 to 500,000, more preferably from 20,000 to 350,000; a polydispersity less than 3.5, more preferably less than 3 and as low as about 2; and a Mooney viscosity (ML (1+4) at 125° C.) from 1 to 250.

In one embodiment, the ethylene multi-block interpolymers have a density of less than about 0.90, preferably less than about 0.89, more preferably less than about 0.885, even more preferably less than about 0.88 and even more preferably less than about 0.875, g/cc. In one embodiment, the ethylene multi-block interpolymers have a density greater than about 0.85, and more preferably greater than about 0.86, g/cc. Density is measured by the procedure of ASTM D-792. Low density ethylene multi-block copolymers are generally characterized as amorphous, flexible, and have good optical properties, for example, high transmission of visible and UV-light and low haze.

In one embodiment, the ethylene multi-block interpolymers have a melting point of less than about 125° C. The melting point is measured by the differential scanning calorimetry (DSC) method described in U.S. Publication 2006/0199930 (WO 2005/090427), incorporated herein by reference.

OBCs are identified by The Dow Chemical Company by the use of the INFUSE™ trademark, and also include D9100, D9150, and D9500 developmental resins.

Whichever polyolefin based polymer is selected for the first polymer for use in the present invention, it must include silane moieties grafted thereto. The silane can be grafted to the polymer by any conventional method, typically in the presence of a free radical initiator, for example peroxides and azo compounds, etc., or by ionizing radiation.

There are several types of compounds that can initiate grafting reactions by decomposing to form free radicals, including azo-containing compounds, carboxylic peroxyacids and peroxyesters, alkyl hydroperoxides, and dialkyl and diacyl peroxides, among others. Many of these compounds and their properties have been described (Reference: J. Branderup, E. Immergut, E. Grulke, eds. “Polymer Handbook,” 4th ed., Wiley, New York, 1999, Section II, pp. 1-76.). It is preferable for the species that is formed by the decomposition of the initiator to be an oxygen-based free radical. It is more preferable for the initiator to be selected from carboxylic peroxyesters, peroxyketals, dialkyl peroxides, and diacyl peroxides. Some of the more preferable initiators, commonly used to modify the structure of polymers, are listed below. Also shown below, are the respective chemical structures and the theoretical radical yields. The theoretical radical yield is the theoretical number of moles of free radicals that are generated per mole of initiator.

| | | Theoretical |
|---|---|---|
| | | Radical |
| Initiator Name | Initiator Structure | Yield |
| Benzoyl peroxide | 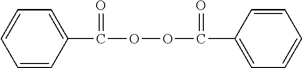 | 2 |
| Lauroyl peroxide | 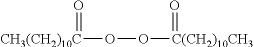 | 2 |
| Dicumyl peroxide | 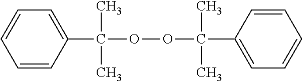 | 2 |
| t-Butyl α-cumyl peroxide | 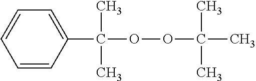 | 2 |
| Di-t-butyl peroxide | 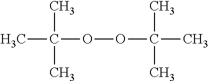 | 2 |
| Di-t-amyl peroxide | 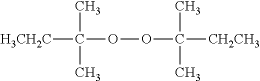 | 2 |
| t-Butyl peroxybenzoate | 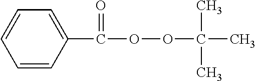 | 2 |
| t-Amyl peroxybenzoate | 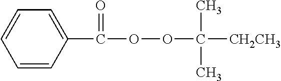 | 2 |
| 1,1-Bis(t-butylperoxy)- 3,3,5- trimethylcyclohexane | 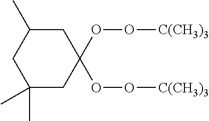 | 4 |
| α,α′-Bis(t- butylperoxy)-1,3- diisopropylbenzene | 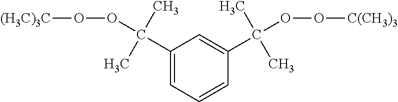 | 4 |
| α,α′-Bis(t- butylperoxy)-1,4- diisopropylbenzene | 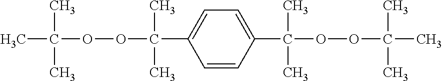 | 4 |
| 2,5-Bis(t- butylperoxy)-2,5- dimethylhexane | 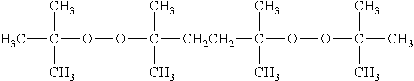 | 4 |
| 2,5-Bis(t- butylperoxy)-2,5- dimethyl-3-hexyne | 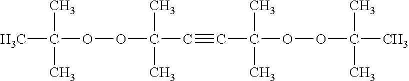 | 4 |

Preferred initiators are the peroxide initiators, for example, dicumyl peroxide, di-tert-butyl peroxide, t-butyl perbenzoate, benzoyl peroxide, cumene hydroperoxide, t-butyl peroctoate, methyl ethyl ketone peroxide, 2,5-dimethyl-2,5-di(tert-butyl peroxy)hexane, lauryl peroxide, and tert-butyl peracetate. A suitable azo compound is 2,2′-azobis(isobutyronitrile).

For some embodiments, the amount of initiator used in the grafting reaction can advantageously be less than, or equal to, 4 millimoles radicals per 100 grams of polyolefin based polymer, preferably, less than, or equal to, 2 millimoles radicals per 100 grams olefin interpolymer, and more preferably, less than, or equal to, 1 millimoles radicals per 100 grams olefin interpolymer. All individual values and subranges from 0.01 millimoles to 4 millimoles radicals per 100 grams olefin interpolymer are included herein and disclosed herein.

Suitable silanes include, but are not limited to, those of the general formula (I):

CH₂═CR—(COO)ₓ(CₙH₂ₙ)_{y}SiR′₃ (I).

In this formula, R is a hydrogen atom or methyl group; x and y are 0 or 1, with the proviso that when x is 1, y is 1; n is an integer from 1 to 12 inclusive, preferably 1 to 4, and each R′ independently is a hydrolyzable group, including, but not limited to, an alkoxy group having from 1 to 12 carbon atoms (e.g. methoxy, ethoxy, butoxy), an aryloxy group (e.g. phenoxy), an araloxy group (e.g. benzyloxy), an aliphatic or aromatic siloxy group, an aromatic acyloxyl group, an aliphatic acyloxy group having from 1 to 12 carbon atoms (e.g. formyloxy, acetyloxy, propanoyloxy), amino or substituted amino groups (alkylamino, arylamino), or a halide such as Cl, Br, or I.

In one embodiment, the silane compound is selected from vinyltrialkoxysilanes, vinyltriacyloxysilanes or vinyltrichlorosilane. In addition, any silane, or mixtures of silanes, which will effectively graft to, and/or crosslink, the olefin interpolymers can be used in the practice of this invention. Suitable silanes include unsaturated silanes that comprise both an ethylenically unsaturated hydrocarbyl group, such as a vinyl, allyl, isopropenyl, butenyl, cyclohexenyl or γ-(meth)acryloxy allyl group, and a hydrolyzable group, such as, a hydrocarbyloxy, hydrocarbonyloxy, or hydrocarbylamino group, or a halide. Examples of hydrolyzable groups include methoxy, ethoxy, formyloxy, acetoxy, proprionyloxy, chloro, and alkylamino or arylamino groups. Preferred silanes are the unsaturated alkoxy silanes which can be grafted onto the polymer. These silanes and their method of preparation are more fully described in U.S. Pat. No. 5,266,627 to Meverden, et al., which is incorporated herein, in its entirety, by reference. Preferred silanes include vinyltrimethoxysilane, vinyltriethoxysilane, 3-(trimethoxysilyl)propyl methacrylate (also known as γ-(meth)acryloxypropyl trimethoxysilane), and mixtures thereof.

The amount of initiator and silane employed will affect the final structure of the silane grafted polymer, such as, for example, the degree of grafting in the grafted polymer and the degree of crosslinking in the cured polymer. The resulting structure, will in turn, affect the physical and mechanical properties of the final product.

The grafting reaction should be performed under conditions that maximize grafts onto the polymer backbone, and minimize side reactions, such as the homopolymerization of grafting agent, which is not grafted to the polymer. Some silane agents undergo minimal or no homopolymerization, due to steric features in the molecular structure, low reactivity and/or other reasons.

For some embodiments, the amount of silane constituent grafted on the polyolefin chain can be greater than, or equal to, 0.05 weight percent (based on the weight of the olefin interpolymer), as determined by FTIR analysis, or other appropriate method. In a further embodiment, this amount is greater than, or equal to, 0.5 weight percent, and in yet a further embodiment, this amount is greater than, or equal to, 1.2 weight percent. In another embodiment, the amount silane constituent grafted on the olefin interpolymer is from 0.5 weight percent to 4.0 weight percent. All individual values and subranges greater than 0.05 weight percent are considered within the scope of this invention, and are disclosed herein.

The silane grafted polyolefin based polymers are blended or otherwise mixed with an amount of non-grafted polyolefin based polymers. The non-grafted polyolefin based polymers can be the same as the base polymer selected for the first polyolefin polymer (that is the polymer prior to grafting) but may also be different. The polyolefin based polymers capable of serving as the second polymer can be any polymer with a unit derived from an olefin as a repeating unit. Preferred polyolefin based polymers for the method of the present invention include the same olefin block copolymers (“OBC”), propylene based plastomers or elastomers (“PBPE”) and linear or substantially linear low density polyethylenes (“LLDPE”) described above for use as the base polymer for the first polyolefin based polymer.

The relative amounts of the first polyolefin based polymer and the second polyolefin based polymer can be selected so as to provide the desired level of crosslinking in the final product given the level of silane grafting on the first polymer. The cross linking levels in the final product can therefore be adjusted by either adjusting the level of grafting on the first polymer or the relative amounts of the first and second polymer. Furthermore, the method of the present invention allows lower gel levels to be obtained as no matter what levels of silane grafting are obtained for the first polymer, after blending with non-grafted polyolefin material, the resulting gel content (i.e. crosslinking level) will be decreased. Thus, this invention is particularly well suited for intended end-use applications where lower crosslinking levels are desired. It has been discovered that fibers used in molded articles such as molded bras, advantageously have relatively low levels of crosslinking.

The weight ratio of first polymer to second polymer can vary from 1:99 to 99:1. All individual values and subranges of ratios between these endpoints are also contemplated to be within the scope of this invention and are included and disclosed herein.

For fiber spinning, it has been observed that the overall mixture preferably has a molecular weight distribution less than 3.0, more preferably less than 2.6, most preferably less than 2.4.

The first and second polyolefin based polymers can be pre-mixed or blended using any device known, such as convection blender (ribbon blender) or diffusion blender (tumble blender). Tumble blenders typically offer the best blend available of all the types mentioned. It is recommended that a nitrogen purge is used during the blending process to reduce the possibility of long chain branching and premature silane crosslinking. It is also convenient to feed the first and second polymers by separate feeder (such as loss-weight-feeder) in a given weight ratio at the feeding hopper of extruder in fiber extrusion process. This method is being practiced by many compounders for making polymer blends with good uniformity. It is also possible that the pre-blending can be done using an extruder, particularly a twin screw extruder.

The polymer blend can then be used in a fiber spinning process to produce a fiber, or the polymer blend can be fabricated into other articles, including films, foams, melt-blown articles, and injection-molded articles, among others. For fibers, the spinning temperature can be from 250° C. to 300° C., more preferably from 265° C. to 290° C. The fiber spun can preferably have a fiber thickness of from 10 to 400 denier, preferably from 10 to 200 denier, or still more preferably from 30 to 140 denier.

After fabrication, the article can be subjected to conditions to facilitate the formation of crosslinks. Typically this involves contacting the article with moisture and/or elevated temperatures. This can be done using humidity from the environment, or a water bath or sauna. In the case of fibers, it is preferred that the spools of fiber be stored in a controlled high humidity atmosphere, preferably at temperatures less than about 50° C. Storage for a few days to a few months under such conditions will enable slow crosslinking such that gel levels greater than about 30 percent by weight as determined from xylene insolubles as set out in ASTM D 2765 can be obtained. This can also advantageously include an additional step of applying a substance to the surface of the fiber catalyze a hydrolysis reaction between the silanes and moisture during the fiber spinning process. When catalyst is added to the surface of the formed article, it is generally advantageous to allow up to one or two days for the catalyst to penetrate the formed article before the article is exposed to high humidity conditions. This is especially preferable in cases where the catalyst can be degraded by contact with moisture, such as when organic titanates or zirconates are used. For other types of articles, it may be advantageous to add catalyst to the silane grafted polymer before or during the melt fabrication step, and then exposing the fabricated article containing the catalyst to moisture.

When a curing catalyst is added, it is anticipated that any of the catalysts generally known in the art may be used, such as tin-containing compounds, N-acrylyl sulfonamide, N-sulfonylsulfonamide, alkylbenzenesulfonic acids, carboxylic acids, Lewis acids, etc. Those catalysts that are preferred include zirconate and titanate compounds such as titanium (IV) bis(acetylacetonate) diisopropoxide, available as TYZOR™ GBA (a trademark of E.I. DuPont de Nemours and Company) and as TYZOR™ AA, titanium (IV) isopropoxide, available as TYZOR™ TPT, titanium (IV) ethoxide, titanium (IV) propoxide, titanium (IV) butoxide, titanium (IV) 2-ethylhexoxide, titanium (IV) 2-ethyl-1,3-hexanediolate, titanium (IV) bis(ethyl acetoacetato) diisopropoxide, titanium (IV) bis(triethanolamino) diisopropoxide, zirconium (IV) propoxide, zirconium (IV) butoxide, and zirconium (IV) tetrakis(acetylacetonate). Most preferred are titanium (IV) bis(acetylacetonate) diisopropoxide, titanium (IV) 2-ethyl-1,3-hexanediolate, zirconium (IV) tetrakis(acetylacetonate), and [2,2-bis(2-propenyloxy)methyl]-1-butanolato-O,O′,O″]-tris(neodecanolato-O) zirconium. The catalyst level is typically less than about 1 percent by weight, more preferably about 0.5 percent by weight or less based on the weight of the fiber.

### EXAMPLES

Unless otherwise stated, the following test methods are used. Density is determined according to ASTM D-792. Melt flow rate for propylene polymers (that is, those polymers comprising greater than 50% by weight of units derived from propylene monomer) is determined according to ASTM D1238, 230° C., 2.16 kg. Melt index, or I₂, for ethylene polymers (that is, those polymers comprising at least 50% by weight of units derived from ethylene monomer) is determined according to ASTM D1238, 190° C., 2.16 kg. Grafting levels are determined using elemental analysis. Gel levels are determined by measuring the amount of xylene insolubles as set out in ASTM D 2765.

The following materials are used in the Examples described below.

Resin A is an ethylene-octene random copolymer, having a melt index of 3 g/10 min, a density of 0.875 g/cm³, and a molecular weight distribution (“MWD”) of 2.13.

Resin B is an ethylene-octene olefin block copolymer (OBC) having an octene content of 18 mol %, a melt index of 1.3 g/10 min, a density of 0.880 g/cm³, and an MWD of 2.60 and a weight ratio of hard block:soft block being 35/65.

Resin C is Resin B which has been silane grafted. The grafting was performed by reacting Resin B with 1.50 wt % vinyltrimethoxysilane (“VTMOS”) premixed with 200 ppm LUPEROX™ 101 (trademark of Arkema, Inc., for 2,5-dimethyl-2,5-di(tert-butylperoxy)hexane) through a 30 mm twin screw extruder in a reactive extrusion process with the extruder temperature set at 220° C. The grafting level achieved is 0.5% as measured by FTIR.

The above materials were spun into fibers as indicated in Table 1

TABLE 1

| Example | Description |
|---|---|
| Comparative #1 | Resin B is spun at a temp of 285° C. at a line speed of 700 m/min |
| | to form a 40d fiber |
| Comparative #2 | Resin C is spun at a temp of 285° C. at a line speed of 700 m/min |
| | to form a 40d fiber which is cured to maximum gel level of |
| | 55.6%. Fiber was cured in water solution containing 10% |
| | dodecylbenzenesulfonic acid at 110° C. for 16 hours. |
| #3 | A blend of 25% Resin B and 75% Resin C is spun at a temp |
| | of 285° C. at a line speed of 700 m/min to form a 40d fiber which is |
| | cured to maximum gel level of 42.7%. Fiber was cured in water |
| | solution containing 10% dodecylbenzenesulfonic acid at 110° C. |
| | for 16 hours. |
| #4 | A blend of 50% Resin B and 50% Resin C is spun at a temp |
| | of 285° C. at a line speed of 700 m/min to form a 40d fiber which is |
| | cured to maximum gel level of 27.5%. Fiber was cured in water |
| | solution containing 10% dodecylbenzenesulfonic acid at 110° C. |
| | for 16 hours. |
| #5 | A blend of 75% Resin B and 25% Resin C is spun at a temp |
| | of 285° C. at a line speed of 700 m/min to form a 40d fiber which |
| | is cured to maximum gel level of 12%. Fiber was cured in water |
| | solution containing 10% dodecylbenzenesulfonic acid at 110° C. |
| | for 16 hours. |
| Comparative #6 | Resin A is spun at a temp of 295° C. at a line speed of 450 m/min |
| | to form a 40d fiber which is then irradiated with electrons at |
| | 176 kGY to produce a fiber having a 65% gel level |
| Comparative # 7 | Resin B is spun at a temp of 295° C. at a line speed of 650 m/min |
| | to form a 40d fiber which is then irradiated with electrons at |
| | 176 kGY to produce a fiber having a 65% gel level |
| Comparative #8 | Resin B is spun at a temp of 295° C. at a line speed of 1000 |
| | m/min to form a 40d fiber which is then irradiated with electrons |
| | at 70 kGY to produce a fiber having a 10% gel level |
| Comparative #9 | Resin B with 0.5 wt % talc added is spun at a temp of 295° C. at a |
| | line speed of 650 m/min to form a 40d fiber which is then |
| | irradiated with electrons at 176 kGY to produce a fiber having a |
| | 65% gel level |
| #10 | 40d blend of 50/50 Resin B and Resin C 700 m/min, 6% cold |
| | draw, cured at 23° C. and 93% relative humidity for 48 hours and |
| | reached a gel level of 18% |
| #11 | 40d blend of 50/50 Resin B and Resin C 700 m/min, 2% cold |
| | draw, cured at 23° C. and 93% relative humidity for 48 hours and |
| | reached a gel level of 18% |

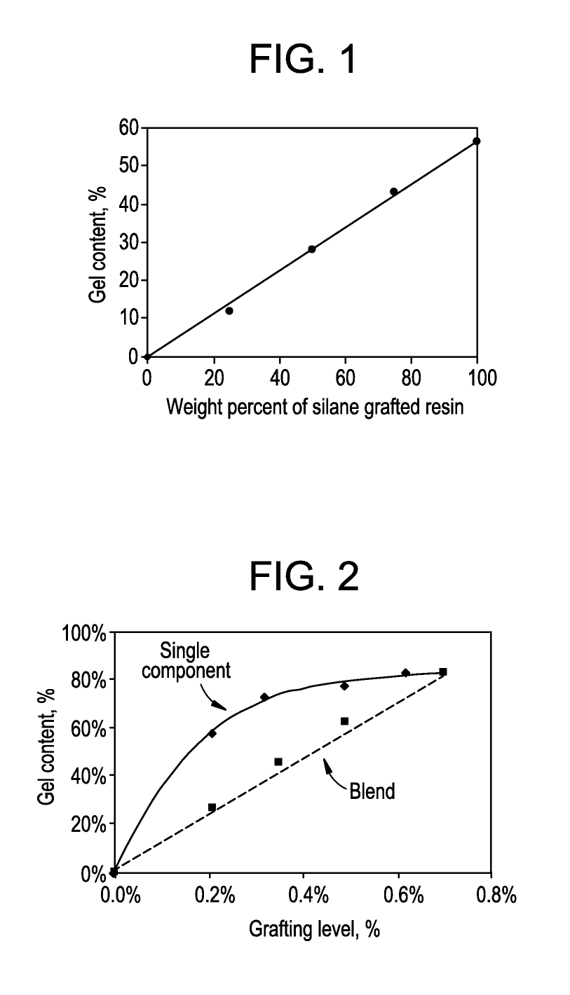

FIG. 1 is a plot of the amount of silane grafted resin versus the resulting gel content for examples 1-5. As seen by this figure the gel level follows the linear mixing rule, indicating that the present invention should facilitate the optimization of the gel content in the resulting fibers.

For a blend of silane grafted resin with non-grafted resin system, the gel level follows the linear mixing rule, as shown in FIG. 1. But for a single component grafting system, the final gel content will be very different from the blend system at the equivalent grafting level. This fact can be illustrated by the following example.

Resin samples of D1 to D5 are prepared starting with resin B with different levels of silane (VTMOS) with a fixed level of LUPEROX™ 101 at 300 ppm. The grafting is performed through a reactive extrusion process on an 18 mm twin screw extruder with the extruder temperature set at 220° C. The grafted products are compression molded to films, and the films are soaked in 10% aqueous dodecylbenzenesulfonic acid solution at 50° C. for 14 days and then 110° C. for 6 days in order to fully crosslink the films. The gel (xylene insoluble) fraction of each is determined. The grafting levels and gel content after curing for these samples are shown in Table 2.

TABLE 2

| | | L101, | grafting | gel |
|---|---|---|---|---|
| Sample | VTMOS | ppm | level | level |
| Resin B | 0.00% | 0 | 0.00% | 0% |
| D1 | 0.22% | 300 | 0.21% | 57% |
| D2 | 0.44% | 300 | 0.32% | 72% |
| D3 | 0.66% | 300 | 0.49% | 77% |
| D4 | 1.00% | 300 | 0.62% | 82% |
| D5 | 1.36% | 300 | 0.70% | 82% |

For a direct comparison with a blend system, a silane grafted resin (Resin E) is made on an 18 mm twin screw extruder starting with Resin B with 1.35 wt % VTMOS and 200 ppm LUPEROX™ 101. The grafting level is measured at 0.70% by FTIR. Resin E is then melt blended in a Haake bowl mixer with un-grafted Resin B at three weight ratios (30:70, 50:50, 70:30) for making samples F1 to F3. The resultant blend resin samples were cured as described above and measured for gel content. The results are shown in Table 3. It is noted that the “nominal” grafting level from these blend samples was determined by a mixing rule based on the weight content of grafted Resin E in the blend system

TABLE 3

| Sample | Resin B | Resin E | grafting | gel level |
|---|---|---|---|---|
| Resin B | 100% | 0% | 0.00% | 0.00% |
| F1 | 70% | 30% | 0.21% | 26% |
| F2 | 50% | 50% | 0.35% | 45% |
| F3 | 30% | 70% | 0.49% | 62% |
| Resin E | 0% | 100% | 0.70% | 81% |

The relationship of gel content versus grafting level for the single component and blend systems are plotted in FIG. 2. It is clearly demonstrated that it is much simpler to target a specific gel level by blending a grafted resin with a non-grafted resin than to try to target that gel fraction in a pure grafted resin.

The tensile properties of Fibers 1-5 at ambient temperatures (approximately 21° C.) are shown in Table 4. The tensile properties of the fibers were measured on an Instron Tester 5564 at a strain rate of 508 mm/min according to ASTM D3922-07. It is seen that load at break showed a descending trend as the content of blend-in silane grafted fibers increased. Silane grafting tended to reduce the stability of crystalline lamellae making fiber softer hence reducing tenacity. It can be see that blending ungrafted resin will improve the tenacity and toughness of the fibers.

TABLE 4

| | Ungrafted/ | Load at | Elongation | load at |
|---|---|---|---|---|
| Fiber Samples | grafted | 300% (g) | to break (%) | break (g) |
| Comparative #1 | 100/0 | 18.6 ± 1.0 | 418 ± 24 | 40.2 ± 2.7 |
| #5 | 75/25 | 15.9 ± 1.0 | 442 ± 10 | 39.7 ± 1.3 |
| #4 | 50/50 | 14.8 ± 0.9 | 440 ± 28 | 38.5 ± 4.1 |
| #3 | 25/75 | 17.6 ± 1.1 | 412 ± 12 | 37.3 ± 1.5 |
| Comparative #2 | 0/100 | 18.2 ± 1.1 | 413 ± 8 | 37.1 ± 0.5 |

The tensile properties of Fibers 1-5 at 95° C. are shown in Table 5. This demonstrates that the blended fibers presented an improved balance of thermal resistance and tenacity versus ungrafted and 100% silane crosslinked fibers

TABLE 5

| | Ungrafted/ | Elongation | Stress at |
|---|---|---|---|
| Fiber Samples | grafted | to break (%) | break (g) |
| Comparative #1 | 100/0 | 231 ± 16 | 2.4 ± 0.1 |
| #5 | 75/25 | 283 ± 7 | 2.9 ± 0.1 |
| #4 | 50/50 | 395 ± 2 | 4.1 ± 0.0 |
| #3 | 25/75 | 399 ± 8 | 5.0 ± 0.2 |
| Comparative #2 | 0/100 | 382 ± 31 | 5.9 ± 0.7 |

The Immediate Cyclic Test (ICT) is performed according to DIN 53835-1981 and the load at 300% strain of fibers at 1^{st} upper cycle and 5^{th} upper cycle are presented in Table 6 along with the coefficient of variation (“CV”). Unexpectedly, uniformity of load at 300% of blend fibers is better than that by using other crosslinked fibers made without blending.

TABLE 6

| | Load at 300%, | | Load at 300%, | |
|---|---|---|---|---|
| Samples | 1^{st} (grams) | CV, % | 5^{th} (grams) | CV, % |
| Comparative #6 | 12.02 | 32.9 | 8.36 | 18.83 |
| Comparative #7 | 9.51 | 27.6 | 7.39 | 1.38 |
| Comparative #8 | 14.9 | 6.91 | 9.69 | 4.89 |
| #10 | 16.16 | 1.63 | 10.78 | 0.58 |
| #11 | 17.71 | 1.45 | 11.38 | 0.50 |

Next, a series of fabrics were made with the above identified elastic fibers. The stretch knit fabric samples were made using a Min-Hua knitting machine. The fabric type was single jersey plain (platting) using PET150d/288f as the hard fiber in each fabric. The detailed information of the fabric manufacturing parameters are listed in Table 7, and results in a fabric having about 9% by weight elastic fiber content.

TABLE 7

| Fabric | | | | | | | | |
|---|---|---|---|---|---|---|---|---|
| Example | Elastic | Gauge/ | Cylinder, | Feed | MM/ | Elastic | | |
| No. | Fibers | needles | in | Length | needle | fiber draft | g/m² | RPM |
| Comparative | Comparative | 26.5 G/ | 32 | 870 | 3.1 | 3.0 | 186 | 18 |
| #12 | #7 | 2808 T | | | | | | |
| Comparative | Comparative | 26.5 G/ | 32 | 870 | 3.1 | 3.0 | 189 | 18 |
| #13 | #9 | 2688 T | | | | | | |
| #14 | #11 | 24.0 G/ | 32 | 740 | 3.1 | 3.0 | 196 | 18 |
| | | 2400 T | | | | | | |

A 20 cm×20 cm specimen of each fabric is washed in boil off testing machine for thirty minutes at the temperature stated in Table 8. The resulting length, width and weight/m² are recorded in Table 8.

TABLE 8

| | | Comparative #12 | | | Example #14 | | |
|---|---|---|---|---|---|---|---|
| No | Temperature | Lengthwise | Widthwise | g/m² | Lengthwise | Widthwise | g/m² |
| 1 | 60° C. | 19.5 | 8.0 | 253 | 18.2 | 8.4 | 269 |
| 2 | 80° C. | 21.4 | 9.4 | 260 | 22.8 | 11.0 | 294 |
| 3 | 100° C. | 23.4 | 11.6 | 270 | 25.2 | 15.2 | 313 |
| 4 | 130° C. | 22.8 | 10.0 | 269 | 18.7 | 13.7 | 284 |

The knit fabric of Example #14 containing elastic fiber made from a 50/50 blend of grafted and ungrafted OBC polyolefin material showed higher retraction power or higher fabric density at a given boiling condition than the comparative fabric made with elastic fiber crosslinked using e-beaming.

In order to evaluate the stability of the fabrics, comparative Fabric #13 and Example #14 in greige forms are then subjected to a standard finishing process for polyester fabrics comprised of:
Continuous scouring, (with 90° C. being the highest temperature in use)
Spinning to reduce wet content by centrifugal force,
Cutting the fabric to open width for subsequent tentering,
Presetting in a tenter (with temperature in chamber set at 170° C. and residence time of 60 seconds, i.e., at 20 m/min)
Dyeing with disperse duestaff, (with 130° C. being the highest temperature in use for 45 minutes)
Spinning to reduce wet content by centrifugal force; and
Final tenter drying and heat setting in order to heat set the PES content of the fabric, (the temperature of the chamber used in this process was set at 160° C. and residence time of 60 seconds was used (at 20 m/min))
   The width and density of finished fabric sample are shown in Table 9.

TABLE 9

| | | | Continuous | | | | | | | |
|---|---|---|---|---|---|---|---|---|---|---|
| | | | Scouring | | | | | | Finished | |
| | Greige | | (dry/wet) | | Presetting | | Dye | | Fabrics | |
| | Fabric | | Fabric | | Fabric | | Fabric | | Fabric | |
| | width | | width | | Width | | Width | | width | |
| Fabric No. | (inch) | g/M² | (inch) | g/M² | inch) | g/M² | (inch) | g/M² | (inch) | g/M² |
| Comparative | 70 | 189 | 69 | 192 | 68 | 194 | 58 | 256 | 62 | 235 |
| #13 | | | | | | | | | | |
| #14 | 62 | 196 | 56 | 257 | 68.5 | 200 | 59.5 | 210 | 63 | 196 |

A fabric of Example #14 having 56 inch width is subjected to heat setting at 160° C. such that the fabric width is increased to 63 inches. The fabric is then subjected to a 49° C. wash and tumble dried according to AATCC 135 WA. After the first wash, the fabric is observed change −1.5% in the lengthwise direction and −0.8% in the widthwise direction. After 3 such washes the fabric is observed change −1.8% in the lengthwise direction and −1.5% in the widthwise direction. This good dimensional stability is indicative of good heat setting efficiency.

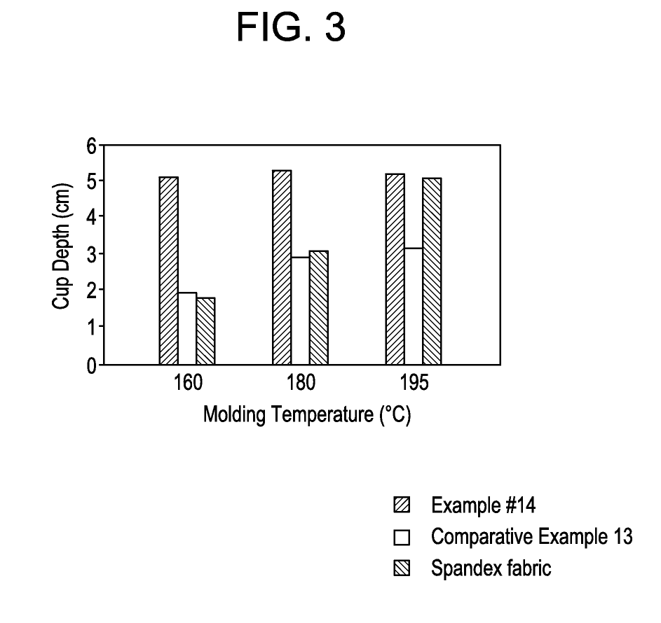

Comparative Fabric #13 and Example #14 are then evaluated for moldability using an Optotexform bra molding machine type 2042-1 as described in US patent publication 2008-0176473, incorporated herein by reference. The molding penetration depth is 6.3 cm and upper diameter of the male mold is 9.4 cm. The molding time is 45 seconds. The temperature is set at 160° C., 180° C. and 195° C. The comparison of cup depth at each molding temperature for Comparative Example 13, Example #14, and a commercial warp knit fabric containing spandex as described in Table 10 is shown in FIG. 3. The warp knit fabric containing spandex has a density of 207 g/m² and is made of nylon (PA6) yarn comprised of 40den filaments and spandex 40den fibers. The spandex content is about 20%. A standard warp knitting process is used for making the fabric, which normally uses 530 mm/rack for spandex, 1500 mm/rack for PA6 yarn of 1500den, and beam draft of 40% for spandex fibers.

As shown in FIG. 3 the knitted fabric containing fiber comprising a blend of silane grafted and ungrafted OBC material had excellent bra moldability over the fabric comprising e-beamed OBC material at any given temperatures, which is attributed to low gel level of the blended fiber. The fabrics made according to the invention also showed excellent low temperature moldability in comparison with the Spandex fabric.

TABLE 10

| | | | | 40% Modulus - | | | |
|---|---|---|---|---|---|---|---|
| | | % Stretch - 36 N | | 36 N | | % Growth - 36 N | |
| Hard yarn | Weight (g/m²) | Length | Width | Length | Width | Length | Width |
| polyamide | 207 | 253 | 142 | 28 | 86 | 35 | 16 |

The following embodiments are considered within the scope of the invention, and applicants reserve the right to file one or more additional applications to specifically aim any of these embodiments not recited in the present claims:

1. A method for producing a crosslinked polyolefin based article comprising the steps of:

a. obtaining an amount of a first polyolefin based polymer which has silane moieties grafted thereon;

b. obtaining an amount of a second polyolefin based polymer which is substantially free of units derived from silane, wherein the ratio of the amount of first polymer to the amount of second polymer is in a range from 1:99 to 99:1;

c. mixing the first polyolefin based polymer and the second polyolefin based polymer;

d. fabricating an article from the mixed resin obtained in step (c);

e. exposing the article to conditions to facilitate a crosslinking reaction between silane moieties.

2. The method of embodiment 1 wherein the first polyolefin based material has been grafted with silane in a process comprising contacting the first polyolefin based material with a free-radical initiator and a silane, wherein the initiator is present in an amount so as to generate 4 millimoles of radicals per 100 grams of first polyolefin based material or less.

3. The method of embodiment 2 wherein the initiator is present in an amount so as to generate 1 millimole of radicals per 100 grams of first polyolefin based material or less.

4. The method of embodiment 2 wherein the silane is present in an amount of at least 0.05% by weight of the first polyolefin based material.

5. The method of embodiment 2 wherein the silane is present in an amount of from 0.5% to 6% by weight of the first polyolefin based material.

6. The method of embodiment 1 wherein the first polyolefin based material is an olefin block copolymer.

7. The method of embodiment 6 wherein the olefin block copolymer has a density of from 0.855/cm³ to 0.955 g/cm³.

8. The method of embodiment 7 wherein the olefin block copolymer has a density of from 0.86 g/cm³ to 0.90 g/cm³.

9. The method of embodiment 8 wherein the olefin block copolymer has a density of from 0.865 g/cm³ to 0.95 g/cm³.

10. The method of embodiment 6 wherein the olefin block copolymer has a molecular weight distribution of from 1 to 7.

11. The method of embodiment 10 wherein the olefin block copolymer has a molecular weight distribution of from 1.5 to 6.

12. The method of embodiment 1 wherein the amount of silane constituent grafted to the first polyolefin based polymer is 0.05% by weight of the first polyolefin based polymer or greater.

13. The method of embodiment 1 wherein the article is a fiber and the fabricating step (d) includes the step of spinning a fiber.

14. The method of embodiment 13 wherein the spinning temperature during step (d) is from 250° C. to 300° C.

15. The method of embodiment 13 wherein the fiber spun in step (d) has a fiber thickness of from 10 to 400 denier.

16. The method of embodiment 13 wherein the fiber spun in step (d) has a fiber thickness of from 10 to 200 denier.

17. The method of embodiment 1 wherein the overall molecular weight distribution of the mixture formed in step (c) is less than 3.0.

18. The method of embodiment 1 wherein the overall molecular weight distribution of the mixture formed in step (c) is less than 2.6.

What is claimed is:

1. A method for producing a crosslinked polyolefin based article comprising the steps of:
a. obtaining an amount of a first polyolefin based polymer which has silane moieties grafted thereon;
b. obtaining an amount of a second polyolefin based polymer which is substantially free of units derived from silane, wherein the ratio of the amount of first polymer to the amount of second polymer is in a range from 1:99 to 99:1;
c. mixing the first polyolefin based polymer and the second polyolefin based polymer;
d. fabricating an article from the mixed resin obtained in step (c);
e. exposing the article to conditions to facilitate a crosslinking reaction between silane moieties.

2. The method of claim 1 wherein the first polyolefin based material has been grafted with silane in a process comprising contacting the first polyolefin based material with a free-radical initiator and a silane, wherein the initiator is present in an amount so as to generate 4 millimoles of radicals per 100 grams of first polyolefin based material or less.

3. The method of claim 2 wherein the initiator is present in an amount so as to generate 1 millimole of radicals per 100 grams of first polyolefin based material or less.

4. The method of claim 1 wherein the silane is present in an amount of from 0.5% to 4% by weight of the first polyolefin based material.

5. The method of claim 1 wherein the first polyolefin based material is an olefin block copolymer.

6. The method of claim 5 wherein the olefin block copolymer has a molecular weight distribution of from 2 to 5.

7. The method of claim 1 wherein the second polyolefin based material is an olefin block copolymer.

8. The method of claim 1 wherein an amount of the second polyolefin based polymer is subjected to silane grafting to form the first polyolefin based polymer.

9. The method of claim 1 wherein the first polyolefin based polymer is selected from the group consisting of linear or substantially linear low density polyethylene having a molecular weight distribution less than 3.0, propylene based plastomer or elastomer, olefin block copolymer and blends thereof.

10. The method of claim 1 wherein the second polyolefin based polymer is selected from the group consisting of linear or substantially linear low density polyethylene having a molecular weight distribution less than 3.0, propylene based plastomer or elastomer, olefin block copolymer and blends thereof.

11. The method of claim 1 wherein the amount of silane constituent grafted to the first polyolefin based polymer is from 0.5% by weight of the first polyolefin based polymer to 4.0%.

12. The method of claim 1 wherein the blend of step (c) comprises at least 50% by weight of the first polyolefin based material.

13. The method of claim 1 wherein the article is a fiber and the fabricating step (d) includes the step of spinning a fiber.

14. The method of claim 13 wherein the spinning temperature during step (d) is from 265° C. to 290° C.

15. The method of claim 14 wherein the fiber spun in step (d) has a fiber thickness of from 30 to 140 denier.

16. The method of claim 1 further comprising adding a material capable of catalyzing the crosslinking reaction to the surface of the article after it has been formed in step (d).

17. The method of claim 1 wherein the overall molecular weight distribution of the mixture formed in step (c) is less than 2.4.

18. The method of claim 1 wherein the mixing step (c) is conducted using an extruder.

19. The method of claim 1 where the article is selected from the group consisting of a film, a foam, or an injection molded part.
